(19) United States
(12) Patent Application Publication
(10) Pub. No.: US 2025/0363610 A1
(43) Pub. Date: Nov. 27, 2025

(54) INSPECTION METHOD, INSPECTION DEVICE, AND RECORDING MEDIUM

(71) Applicant: Magnolia Blue Corporation, Minato-ku, Tokyo (JP)

(72) Inventor: Shinichiro HASHIMOTO, Minato-ku, Tokyo (JP)

(21) Appl. No.: 18/996,052

(22) PCT Filed: Aug. 2, 2023
(86) PCT No.: PCT/JP2023/028231

§ 371 Date: Jan. 17, 2025

(30) Foreign Application Priority Data
Aug. 3, 2022 (JP) 2022-124338

(51) Int. Cl. G06T 7/00; G06T 7/194; G06T 7/60; G06T 7/90; G06V 10/764; G06V 10/774; G06V 10/82

(52) U.S. Cl. CPC G06T 7/0004; G06T 7/194; G06T 7/60; G06T 7/90; G06V 10/764; G06V 10/774; G06V 10/82; G06T 2207/20081; G06T 2207/20084

(57) ABSTRACT

An inspection method performed by a computer for inspecting a display panel includes: obtaining an anomalous portion image that includes an anomalous portion of a pixel region of the display panel, the anomalous portion being acquired by performing image processing using a background subtraction method on an inspection image of the pixel region; generating, using a trained generative model, a label image from the anomalous portion image by converting a region indicating the anomalous portion into a region of a color corresponding to a fault mode of the anomalous portion; and determining, based on the color of the region in the label image, whether the fault mode of the anomalous portion has a possibility of being a seepage defect in which light is not emitted due to deterioration of a functional layer in the pixel region. The fault mode includes the seepage defect and a dark-dot defect.

### TECHNICAL FIELD

The present disclosure relates to an inspection method, an inspection device, and a program.

### BACKGROUND ART

During the production process of organic EL display panels, various inspections are conducted to maintain product quality.

Among various inspection steps, a DS (Dark Spot) inspection is performed in an inspection step of inspecting display defects in a pixel region to inspect if there are any black stain-like display defects (hereinafter referred to as “seepage defects”) caused by faults in a moisture barrier layer.

In the DS inspection, an operator checks an enlarged image of the pixel region and, if a region (hereinafter referred to as a “seepage region”) where moisture has seeped into a light-emitting layer of the pixel region appears in the image, the operator determines whether the region is a seepage defect according to the size of the seepage region.

However, since display defects of pixel regions include display defects other than seepage defects such as display defects caused by dark dots or the like, the operator also needs to determine a defect mode (hereinafter referred to as a fault mode). Both a determination of the fault mode and a measurement of the size of the seepage region are left to the operator's judgment. Therefore, differences in judgment criteria may occur among operators, and even with the same operator, fluctuations in judgment criteria may occur over time. As a result, there are problems of an occurrence of an overkill where a good product is judged as a defective product and an occurrence of an underkill where a defective product is judged as a good product.

In contrast, for example, Patent Literature (PTL) 1 proposes an image classification method that automatically classifies images of detected faults in appearance inspections.

### CITATION LIST

### Patent Literature

PTL 1: Japanese Unexamined Patent Application Publication No. 2017-054239

### SUMMARY OF INVENTION

### Technical Problem

However, a seepage defect in a pixel region of an organic EL display panel is not taken into consideration as a type of fault in PTL 1. In other words, the image classification method according to PTL 1 can only classify foreign substances, defects, and bubbles as types of faults and is unable to classify seepage defects in the pixel region of an organic EL display panel.

The present disclosure has been made in consideration of the situation described above and an object thereof is to provide an inspection method and the like which enable a determination of a fault mode in a pixel region of a display panel to be automatically performed.

### Solution to Problem

In order to achieve the object described above, an inspection method according to an aspect of the present disclosure is an inspection method to be performed by a computer for inspecting a display panel, the inspection method including: obtaining an anomalous portion image that is an image including an anomalous portion of a pixel region of the display panel, the anomalous portion being acquired by performing image processing using a background subtraction method on an inspection image of the pixel region; generating, using a trained generative model, a label image from the anomalous portion image by converting a region indicating the anomalous portion into a region of a color corresponding to a fault mode of the anomalous portion; and determining, based on the color of the region in the label image, whether the fault mode of the anomalous portion has a possibility of being a seepage defect in which light is not emitted due to deterioration of a functional layer in the pixel region, wherein the fault mode includes the seepage defect and a dark-dot defect in which light is not emitted due to an electrical short circuit or an electrical open circuit in the pixel region.

Accordingly, a determination of a fault mode in a pixel region of a display panel can be automatically performed.

In addition, the inspection method may further include, prior to the determining, obtaining a classification result from the anomalous portion image by using a trained convolutional neural network (CNN) model, the classification result indicating the fault mode of the anomalous portion, and in the determining, whether the fault mode of the anomalous portion has the possibility of being the seepage defect may be determined based on the classification result obtained in the obtaining of the classification result and the color of the region in the label image.

In addition, for example, in the determining, whether the fault mode of the anomalous portion has the possibility of being the seepage defect may be determined by the computer when the fault mode indicated by the classification result obtained in the obtaining of the classification result and the fault mode indicated by the color of the region in the label image are identical, and when the fault modes are not identical, a notification that the fault modes are not identical may be made to cause an operator to determine whether the fault mode of the anomalous portion has the possibility of being the seepage defect, the inspection method may further include: measuring a size of the region in the label image to determine whether the size measured is greater than or equal to a predetermined value when, in the determining, the fault mode of the anomalous portion is determined to have the possibility of being the seepage defect; and determining that the fault mode of the anomalous portion is the seepage defect when the size of the region is determined, in the measuring, to be greater than or equal to the predetermined value.

In addition, for example, the inspection method may include: measuring a size of the region in the label image to determine whether the size measured is greater than or equal to a predetermined value when, in the determining, the fault mode of the anomalous portion is determined to have the possibility of being the seepage defect; and determining that the fault mode of the anomalous portion is the seepage defect when the size of the region is determined, in the measuring, to be greater than or equal to the predetermined value.

In addition, for example, the trained generative model is trained using (i) an anomalous portion image for training that is obtained by performing image processing using the background subtraction method on an inspection image of the pixel region of the display panel and (ii) a label image for training that is obtained by converting a region indicating an anomalous portion shown in the anomalous portion image for training, into a region of a color corresponding to a fault mode of the anomalous portion, the anomalous portion image for training and the label image for training being prepared as teaching data, and the fault mode of the anomalous portion indicates the dark-dot defect, the seepage defect, or a normal state.

Here, for example, the trained generative model may be a generative adversarial networks (GAN)-based neural network model. In addition, for example, the trained generative model may be a Pix2Pix neural network model.

In addition, for example, the anomalous portion image for training may be subjected to histogram adjustment to make a background region uniformly white, the background region excluding the region indicating the anomalous portion.

Note that these general or specific aspects may be implemented as a device, a method, an integrated circuit, a computer program, a computer-readable recording medium such as a compact disc read-only memory (CD-ROM), or as any combination of systems, methods, integrated circuits, computer programs, and recording media.

### Advantageous Effects of Invention

The present disclosure can provide an inspection method and the like which enable a determination of a fault mode in a pixel region of a display panel to be automatically performed.

### BRIEF DESCRIPTION OF THE DRAWINGS

FIG. 1 is a diagram illustrating a schematic configuration of an inspection system including an inspection device according to an embodiment.

FIG. 2A illustrates an example of an enlarged image of an inspection image used in a DS inspection according to the embodiment.

FIG. 2B illustrates an example of an enlarged image of an inspection image used in a DS inspection according to the embodiment.

FIG. 3 is a schematic diagram for describing a mechanism of occurrence of a seepage defect.

FIG. 4A illustrates an example of the size of a seepage region that appears in an enlarged image of an inspection image used in the DS inspection according to the embodiment.

FIG. 4B illustrates an example of the size of a seepage region that appears in an enlarged image of an inspection image used in the DS inspection according to the embodiment.

FIG. 5 is a diagram illustrating an example of a hardware configuration of a computer that realizes functions of the inspection device according to the embodiment by software.

FIG. 6 is a block diagram illustrating an example of a functional configuration of the inspection device according to the embodiment.

FIG. 7 is another example of an enlarged image of an inspection image of an organic EL display panel used in a DS inspection according to the embodiment.

FIG. 8 is a diagram illustrating an example of an anomalous portion image obtained from the enlarged image of the inspection image illustrated in FIG. 7.

FIG. 9 is a diagram illustrating an example of a label image according to the embodiment.

FIG. 10 is a diagram illustrating an example of an image pair prepared as teaching data according to the embodiment.

FIG. 11A is a diagram illustrating another example of an image pair prepared as teaching data according to the embodiment.

FIG. 11B is a diagram illustrating another example of an image pair prepared as teaching data according to the embodiment.

FIG. 11C is a diagram illustrating another example of an image pair prepared as teaching data according to the embodiment.

FIG. 11D is a diagram illustrating another example of an image pair prepared as teaching data according to the embodiment.

FIG. 12 is a diagram conceptually illustrating a method of training a generative model using an image pair such as those illustrated in FIGS. 10 to 11D as teaching data.

FIG. 13 is a diagram for conceptually describing the size measurement of a color label portion of a label image according to the embodiment.

FIG. 14 is a flowchart showing operations of the inspection device according to the embodiment.

FIG. 15 is a block diagram illustrating an example of a functional configuration of an inspection device according to a variation of the embodiment.

FIG. 16 is a flowchart showing a part of operations of the inspection device according to the variation of the embodiment.

### DESCRIPTION OF EMBODIMENTS

Hereinafter, embodiments of the present disclosure will be described in detail with reference to the drawings. Note that each of the embodiments described below shows a specific example of the present disclosure. The numerical values, shapes, materials, standards, constituent elements, the arrangement and connection of the constituent elements, steps, the processing order of the steps, etc., indicated in the embodiments below are mere examples, and do not intend to limit the present disclosure. Also, among the constituent elements in the embodiments below, those not recited in any one of the independent claims of the present disclosure will be described as optional elements. Furthermore, each drawing is not necessarily a strict representation. In the drawings, the same reference signs are given to substantially the same elements, and duplicate description may be omitted or simplified.

### Embodiment

Hereinafter, an inspection device and the like according to the present embodiment will be described.

### 1. Inspection System

Hereinafter, inspection device 10 according to the present embodiment will be described with reference to the drawings.

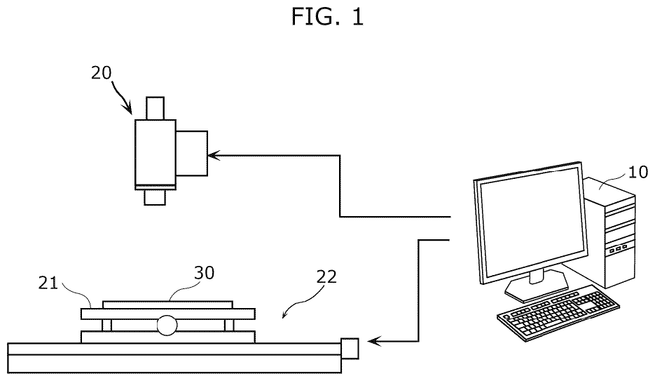

FIG. 1 is a diagram illustrating a schematic configuration of an inspection system including inspection device 10 according to the present embodiment. In the present embodiment, a case where an inspection object of inspection device 10 is organic EL display panel 30 will be described as an example. The inspection object of inspection device 10 may be a display panel using a quantum dot light-emitting diode (QLED).

The inspection system illustrated in FIG. 1 includes inspection device 10, imaging device 20, stage 21, and stage driver 22.

Inspection device 10 is a device for automatically performing a DS inspection which inspects whether or not a seepage defect is present in a pixel region of organic EL display panel 30. As described earlier, a seepage defect is a black stain-like display defect caused by faults in a moisture barrier layer. More specifically, the seepage defect according to the present embodiment is a display defect in which light is not emitted due to a degradation of functional layers including a light-emitting layer in the pixel region and is one of the fault modes. Typically, a degradation of functional layers including the light-emitting layer is caused by moisture. In addition, the seepage defect often appears as a display defect in which moisture has seeped to the light-emitting layer in the pixel region. In other words, the seepage defect appears as a defect in which a region (seepage region) where moisture has seeped into the light-emitting layer of organic EL display panel 30 appears in an enlarged image of the pixel region and the size of the seepage region equals or exceeds a predetermined value. A mechanism of occurrence of seepage defects will be described later.

Imaging device 20 captures images of an inspection object region on organic EL display panel 30 and is constituted of a CCD (Charge Coupled Device) or a CMOS (Complementary Metal-Oxide Semiconductor). More specifically, imaging device 20 acquires an inspection image of organic EL display panel 30 by capturing a pixel region that is an inspection object region on organic EL display panel 30. Note that imaging device 20 is controlled by inspection device 10, and, alternatively, imaging device 20 may be controlled by another computer.

Stage 21 holds organic EL display panel 30.

Stage driver 22 is constituted of a ball screw, a guide rail, and a motor and relatively moves stage 21 with respect to imaging device 20. Note that stage driver 22 is controlled by inspection device 10, and, alternatively, stage driver 22 may be controlled by another computer.

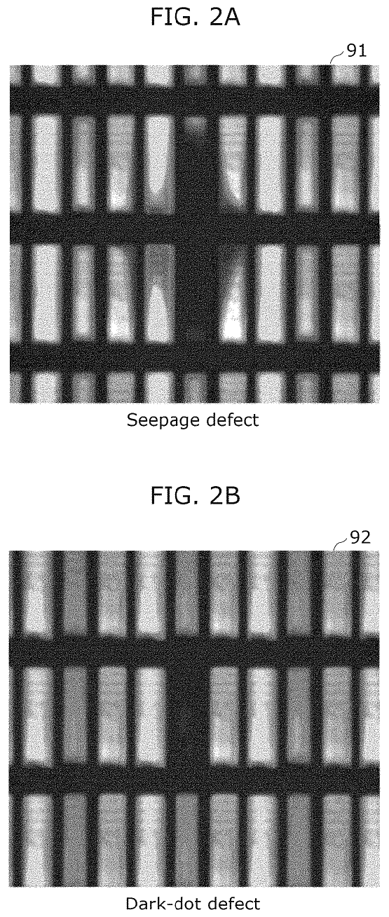

FIGS. 2A and 2B are examples of enlarged images of inspection images used in a DS inspection according to the present embodiment. FIG. 2A illustrates an example of a case where a seepage region that constitutes a seepage defect appears in enlarged image 91 of a pixel region of organic EL display panel 30. In addition, FIG. 2B illustrates an example of a case where dark dots (dark-dot region) that constitutes a dark-dot defect appears in enlarged image 92 of a pixel region of organic EL display panel 30. Note that dark dots are light-emitting pixels that do not emit light (is not lighted) due to an electrical short circuit or an electrical open circuit of the pixel region, and dark dots may include light-emitting pixels with low emission luminance.

Note that when the operator performs the DS inspection himself/herself, the operator is to identify whether or not a seepage region or dark dots appear in the enlarged image of the pixel region by a contour shape. Since the seepage region is a region where moisture seeps to a light-emitting layer of the pixel region and where a region where the moisture seeps grows and becomes larger over time or the like, the seepage region has a smooth contour and can be distinguished from a dark-dot region with a contour that is not smooth. However, it is difficult to distinguish contours from each other and, depending on the operator, a seepage region may be erroneously determined to be a dark-dot region.

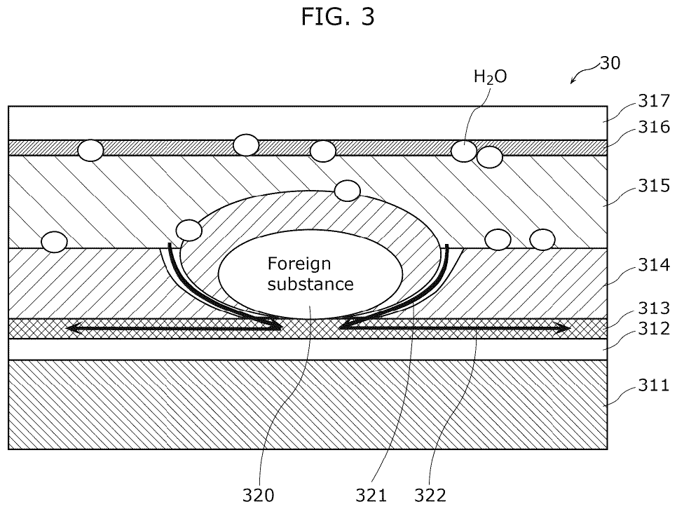

FIG. 3 is a schematic diagram for describing a mechanism of occurrence of a seepage defect. FIG. 3 schematically illustrates an example of a sectional view of the pixel region of organic EL display panel 30. For example, as illustrated in FIG. 3, organic EL display panel 30 includes glass substrate 311, thin-film transistor layer 312 formed on glass substrate 311, light-emitting layer 313 formed on thin-film transistor layer 312, and protective film 314 formed on light-emitting layer 313. Protective film 314 functions as a moisture barrier layer for blocking moisture. In addition, in organic EL display panel 30, an upper substrate is formed on protective film 314 via filler 315 such as an adhesive. In the example illustrated in FIG. 3, the upper substrate is formed of color filter layer 316 and glass substrate 317. Furthermore, color filter layer 316 includes a black matrix (BM) that partitions a pixel region and the pixel region. Note that the upper substrate may be a substrate constituted of a flexible polarizing plate or the like.

As illustrated in FIG. 3, it is assumed that, when forming protective film 314 of organic EL display panel 30, foreign substance 320 is included in protective film 314 and a gap is created in protective film 314. In other words, it is assumed that a fault of the moisture barrier layer has occurred in organic EL display panel 30. Then, moisture that is indicated as H₂O in FIG. 3 falls from color filter layer 316 or the like to protective film 314. Note that moisture may include moisture contained in filler 315 in addition to moisture included in color filter layer 316. Next, the moisture having fallen on protective film 314 penetrates into the gap in protective film 314 and adsorbs on light-emitting layer 313. In this manner, the moisture having fallen on protective film 314 penetrates into protective film 314 through penetration path 321 and adsorbs on light-emitting layer 313. Furthermore, for example, a moisture adsorption area progresses in a direction of arrow 322 or, in other words, along light-emitting layer 313. In this manner, a region where moisture seeps spreads to the light-emitting layer of the pixel region. Note that since heat is a dominant factor promoting progression, the region of seepage expands with temperature and time. Therefore, the size of the seepage region that becomes defective at the time of DS inspection is determined based on the size of the seepage region that can be treated as a good product at an end of a product lifetime of the organic EL display panel. In this case, the size of the seepage region that becomes defective at the time of DS inspection is, for example, in the order of several ten microns.

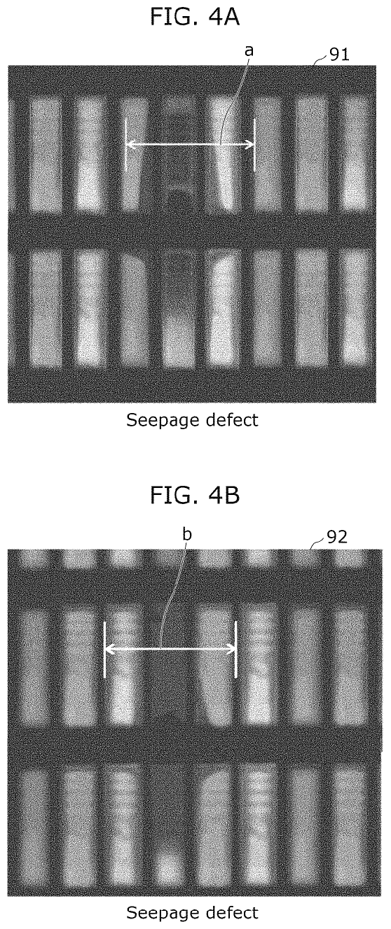

FIGS. 4A and 4B illustrate examples of the sizes of seepage regions that appear in enlarged images of inspection images used in the DS inspection according to the present embodiment. FIGS. 4A and 4B illustrate the sizes of seepage regions that appear in enlarged images of a pixel region of organic EL display panel 30.

Note that when the operator performs the DS inspection himself/herself, the operator is to measure the size of the seepage region that appears in an enlarged image of the pixel region. However, as illustrated in FIGS. 4A and 4B, since the seepage region is partially blocked by the partition between pixels or, in other words, the BM, it is difficult for the operator to recognize an end of the seepage region. As a result, depending on the operator, a variation is created in the measurement of the size of the seepage region.

### 1-1. Hardware Configuration of Inspection Device 10

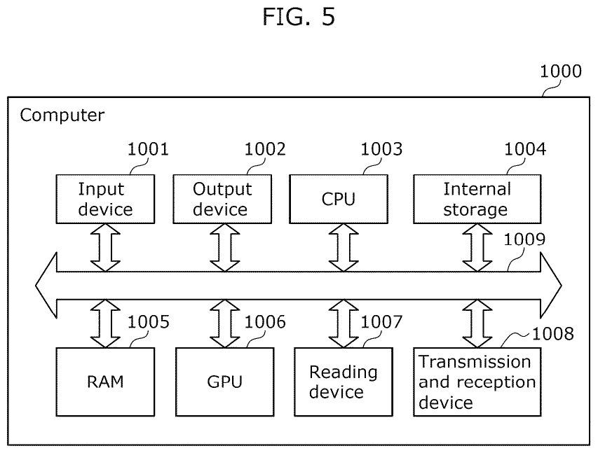

Before describing a functional configuration of inspection device 10 according to the present embodiment, an example of a hardware configuration of inspection device 10 according to the present embodiment will be described using FIG. 5.

FIG. 5 is a diagram illustrating an example of a hardware configuration of computer 1000 that realizes functions of inspection device 10 according to the present embodiment by software.

As illustrated in FIG. 5, computer 1000 is a computer including input device 1001, output device 1002, CPU 1003, internal storage 1004, RAM 1005, GPU 1006, reading device 1007, transmission and reception device 1008, and bus 1009. Input device 1001, output device 1002, CPU 1003, internal storage 1004, RAM 1005, GPU 1006, reading device 1007, and transmission and reception device 1008 are connected by bus 1009.

Input device 1001 is a device to be a user interface such as an input button, a touch pad, or a touch panel display and accepts operations by a user. Note that in addition to accepting contact operations of the user, input device 1001 may be configured to accept operations by voice, remote operations using a remote controller, and the like.

Output device 1002 is used in conjunction with input device 1001 and is constituted of a touch pad or a touch panel display, and the like, and notifies the user of information that the user should be aware of.

Internal storage 1004 is a flash memory or the like. In addition, internal storage 1004 may store, in advance, at least one of a program for realizing the functions of inspection device 10 and an application using the functional configuration of inspection device 10. Furthermore, internal storage 1004 may store a neural network model (such as a generative model), acquired training data, parameters such as intermediate layers of the model, procedures for performing image processing such as a background subtraction method, procedures for performing determinations such as a non-dark-dot defect determination and a DS determination to be described later, and the like.

RAM 1005 is a random access memory and is used to store data and the like when executing the program or the application.

GPU 1006 is a graphics processing unit that copies a program, an application, and data stored in internal storage 1004 to a dedicated RAM built into the GPU and executes graphics processing according to instructions contained in the program or application.

Reading device 1007 reads information from a recording medium such as a USB (Universal Serial Bus) memory. Reading device 1007 reads the program or the application described above from a recording medium in which the program or the application is recorded and causes the program or the application to be stored in internal storage 1004.

Transmission and reception device 1008 is a communication circuit for performing wireless or wired communication. Transmission and reception device 1008 may communicate with, for example, a server device connected to a network to download the program or the application described above from the server device and store the program or the application in internal storage 1004.

CPU 1003 is a central processing unit that copies a program or an application stored in internal storage 1004 to RAM 1005, sequentially reads instructions contained in the program or the application from RAM 1005, and executes the instructions.

### 1-2. Functional Configuration of Inspection Device 10

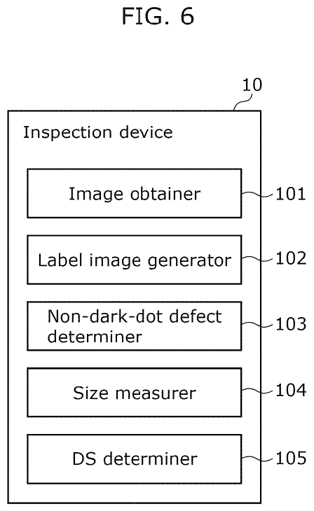

Next, each functional element of inspection device 10 according to the present embodiment will be described using FIG. 6.

FIG. 6 is a block diagram illustrating an example of a functional configuration of inspection device 10 according to the present embodiment.

As illustrated in FIG. 6, inspection device 10 includes image obtainer 101, label image generator 102, non-dark-dot defect determiner 103, size measurer 104, and DS determiner 105. Note that size measurer 104 and DS determiner 105 are not essential in inspection device 10 and may be provided outside of inspection device 10.

### 1-2-1. Image Obtainer 101

Image obtainer 101 obtains an anomalous portion image that is an image including an anomalous portion of a pixel region of organic EL display panel 30. Here, the anomalous portion is acquired by performing image processing using a background subtraction method on an inspection image of the pixel region.

In the present embodiment, image obtainer 101 obtains, from imaging device 20, an inspection image of a pixel region of organic EL display panel 30 to be used in a DS inspection. In addition, image obtainer 101 performs image processing using a background subtraction method on the obtained inspection image and generates an anomalous portion image that is a background subtraction image including an anomalous portion of a pixel region of organic EL display panel 30. Note that image obtainer 101 can realize various functions such as an inspection image obtaining function, an image processing function, and an anomalous portion image generation function by having a processor execute a control program stored in a memory in a computer that realizes the functions of inspection device 10.

In this case, the background subtraction method is image processing that compares an observed image and a background image with each other to extract objects that are not present in the background image but are present in the observed image. In the present embodiment, the image processing involves taking a difference between an anomalous pixel image and a normal pixel image to remove normal brightness distribution information from the anomalous pixel image and extract only the anomalous portion. The anomalous pixel image is an image including anomalous pixels that include a seepage region and dark dots and which is an enlarged image of the inspection image of a pixel region of organic EL display panel 30. The normal pixel image is an image including normal pixels that do not include a seepage region and dark dots and which is an enlarged image of the inspection image of a pixel region of organic EL display panel 30.

In addition, the normal pixel image is an image that does not include any anomalous portions in the pixel region of organic EL display panel 30 at a different position from the anomalous portions in the inspection image. In other words, the normal pixel image is an image of a same scale as the image of the region containing the anomalous portion in the inspection image. Note that the normal pixel image may be an image obtained from the inspection image or an image of the same scale as the inspection image and prepared in advance.

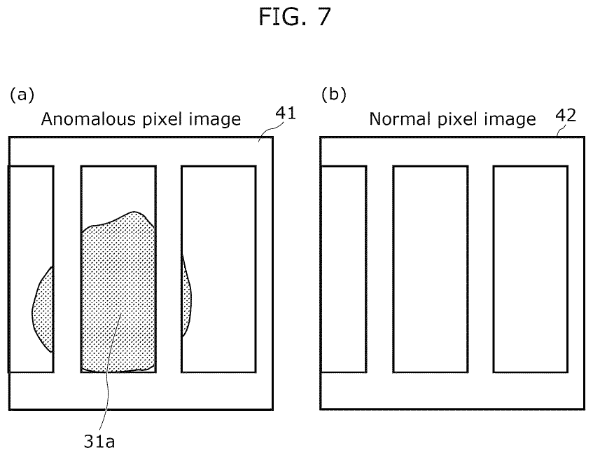

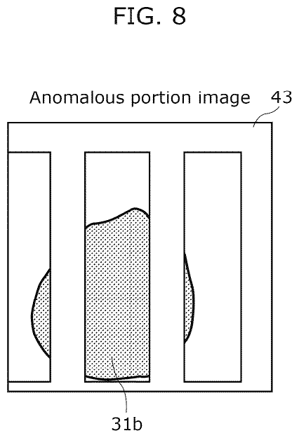

Hereinafter, an example of a case of generating an anomalous portion image by the background subtraction method will be described with reference to FIGS. 7 and 8. FIG. 7 is another example of an enlarged image of an inspection image of organic EL display panel 30 used in a DS inspection according to the present embodiment. Anomalous pixel image 41 including anomalous portion 31a that is a seepage region is illustrated in (a) in FIG. 7, and normal pixel image 42 is illustrated in (b) in FIG. 7. FIG. 8 is a diagram illustrating an example of anomalous portion image 43 obtained from the enlarged image of the inspection image illustrated in FIG. 7.

In other words, image obtainer 101 performs image processing using the background subtraction method and, by taking a difference between anomalous pixel image 41 illustrated in (a) in FIG. 7 and normal pixel image 42 illustrated in (b) in FIG. 7, removes normal brightness distribution information from the anomalous pixel image and extracts only the anomalous portion. Accordingly, image obtainer 101 can generate anomalous portion image 43 including anomalous portion 31b as illustrated in FIG. 8. Anomalous portion image 43 illustrated in FIG. 8 is an image from which only anomalous portion 31a illustrated in (a) in FIG. 7 is extracted.

In this manner, image obtainer 101 can obtain an anomalous portion image.

### 1-2-2. Label Image Generator 102

Label image generator 102 generates, using a trained generative model, a label image from the anomalous portion image obtained by image obtainer 101, by converting a region indicating the anomalous portion into a region of a color corresponding to the fault mode of the anomalous portion. Note that label image generator 102 can realize a label image generation function using a trained generative model by having a processor execute a control program stored in a memory in a computer that realizes the functions of inspection device 10. The trained generative model is trained and generated using an anomalous portion image for training and a label image for training that are prepared as teaching data. The anomalous portion image for training is an image obtained by performing image processing using the background subtraction method on an inspection image of the pixel region of organic EL display panel 30. The label image for training is an image obtained by converting a region indicating an anomalous portion shown in the anomalous portion image for training, into a region of a color corresponding to the fault mode of the anomalous portion. The fault mode of the anomalous portion indicates the dark-dot defect, the seepage defect, or a normal state.

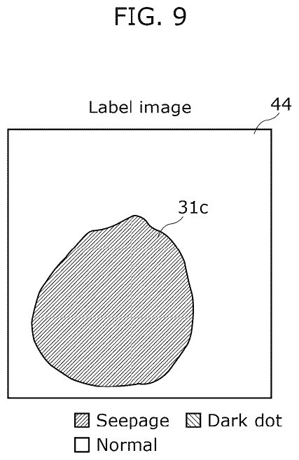

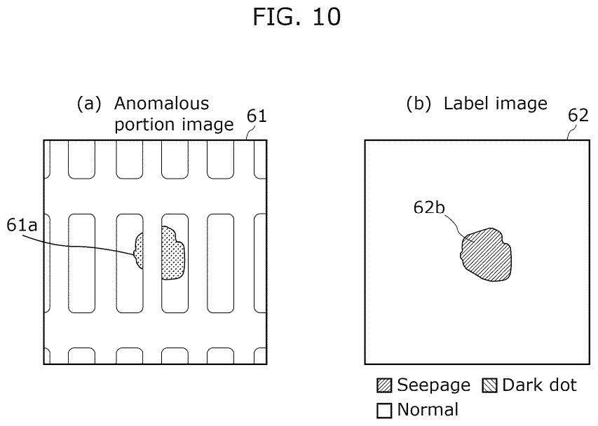

FIG. 9 is a diagram illustrating an example of label image 44 according to the present embodiment. Label image 44 illustrated in FIG. 9 is an image including color label portion 31c created by converting the region of anomalous portion 31b of anomalous portion image 43 illustrated in FIG. 8 into a color region (color label) in accordance with the fault mode of anomalous portion 31b.

In the present embodiment, for example, label image generator 102 generates, from anomalous portion image 43 illustrated in FIG. 8, label image 44 illustrated in FIG. 9 including color label portion 31c created by converting the region of anomalous portion 31b included in anomalous portion image 43 into a color label in accordance with the fault mode of anomalous portion 31b. Note that the fault mode of anomalous portion 31b is, for example, the seepage defect, the dark-dot defect, or the normal state as described above. In addition, in color label portion 31c, partitions between pixels in the region of anomalous portion 31b or, in other words, a missing portion that is shielded by the BM is complemented by a color in accordance with the fault mode.

In the present embodiment, a generative model being a neural network model that complements one image of an image pair for training from the other image is used to generate label image 44. Here, the generative model according to the present embodiment is, for example, a Pix2Pix neural network model. Pix2Pix is a generative model that automatically extracts a latent relationship between images of an image pair for training using a neural network and uses the extracted relationship to complement one image of the image pair from the other image. Note that as long as the generative model according to the present embodiment is constituted of a neural network model such as Generative Adversarial Networks (GAN) that performs adversarial generative learning of an image pair, the generative model may be configured in any way. That is, the generative model according to the present embodiment may have any configuration as long as it is a GAN-based neural network model.

Next, an example of a learning method of a generative model that generates a label image from an anomalous portion image will be described.

FIG. 10 is a diagram illustrating an example of an image pair prepared as teaching data according to the present embodiment. Anomalous portion image 61 and label image 62 thereof illustrated in FIG. 10 are an example of an image pair prepared as teaching data. Anomalous portion image 61 including anomalous portion 61a that is a seepage region is illustrated in (a) in FIG. 10. Label image 62 including color label portion 62b created by converting (transforming) a region of anomalous portion 61a of anomalous portion image 61 to a corresponding color (in the diagram, hatching) when the fault mode of anomalous portion 61a is a seepage defect is illustrated in (b) in FIG. 10. Note that in color label portion 62b, partitions between pixels in anomalous portion 61a or, in other words, a missing portion that is shielded by the BM is converted into a color corresponding to a case where the fault mode of anomalous portion 61a is a seepage defect.

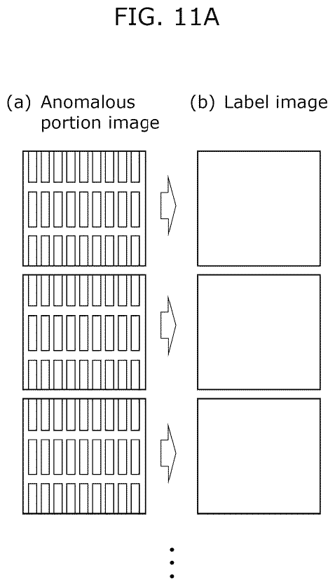

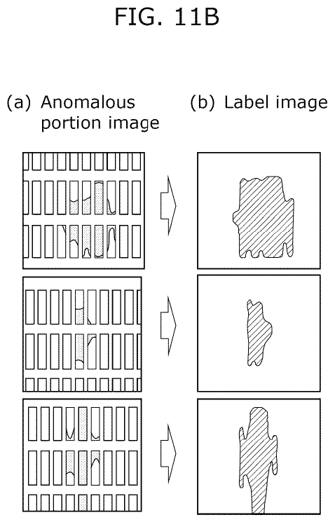

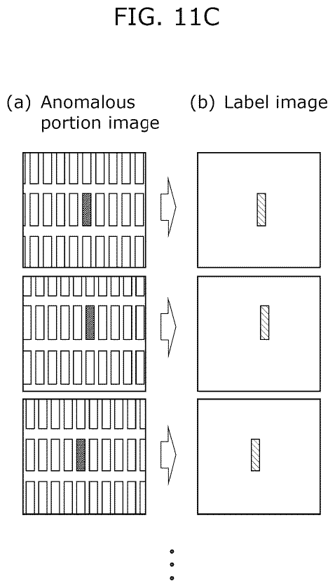

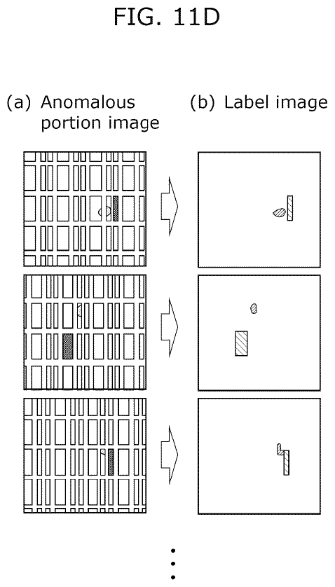

FIGS. 11A to 11D are diagrams each illustrating another example of an image pair prepared as teaching data according to the present embodiment.

An example of a normal image or, in other words, an anomalous portion image without an anomalous portion is illustrated in (a) in FIG. 11A. A label image in a case where the fault mode of the anomalous portion image is a normal state is illustrated in (b) in FIG. 11A. Since the anomalous portion image illustrated in (a) in FIG. 11A does not have an anomalous portion, the label image in (b) in FIG. 11A is an image including a white color label portion indicating a normal state.

An example of an anomalous portion image including an anomalous portion that is a seepage region is illustrated in (a) in FIG. 11B. A label image including a color label portion depicted by corresponding hatching when the fault mode of the anomalous portion image is a seepage defect is illustrated in (b) in FIG. 11B.

An example of an anomalous portion image including an anomalous portion that is dark dots is illustrated in (a) in FIG. 11C. A label image including a color label portion depicted by corresponding hatching when the fault mode of the anomalous portion image is a dark-dot defect is illustrated in (b) in FIG. 11C.

An example of an anomalous portion image including an anomalous portion with a mixture of seepage regions and dark dots is illustrated in (a) in FIG. 11D. A label image including a color label portion depicted by hatchings corresponding to respective fault modes of the anomalous portion of the anomalous portion image is illustrated in (b) in FIG. 11D.

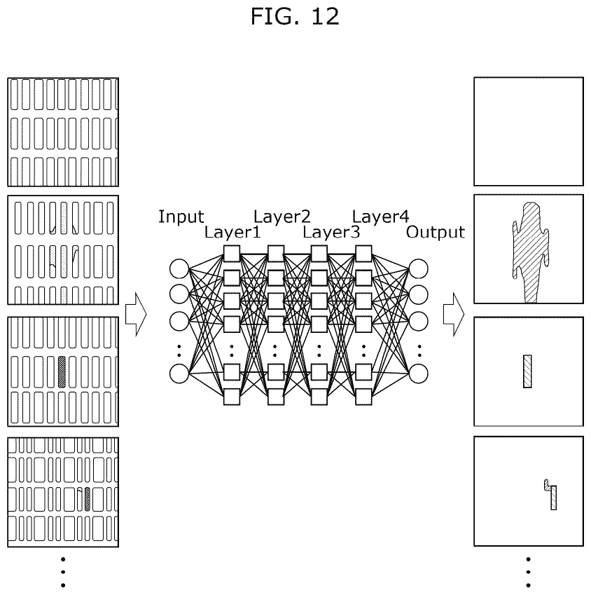

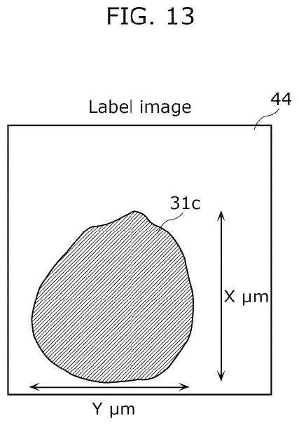

FIG. 12 is a diagram conceptually illustrating a method of training a generative model using an image pair such as those illustrated in FIGS. 10 to 11D as teaching data. Note that in the example of the anomalous portion image input in FIG. 12, pixels are indicated by white frames and an anomalous portion is hatched except for portions to be shielded by the BM in order to conceptually represent the anomalous portion image.

When training the generative model that generates a label image from an anomalous portion image, first, an image pair such as those illustrated in FIGS. 10 to 11D made up of an anomalous portion image and a label image is prepared in plurality. Next, as illustrated in FIG. 12, a GAN-based neural network that constitutes the generative model is trained in a supervised manner so that an input is the anomalous portion image and an output is a corresponding label image. Accordingly, a generative model that generates a label image when an anomalous portion image is input can be obtained.

Note that although a neural network that constitutes the generative model according to the present embodiment is conceptually illustrated in FIG. 12, it is sufficient as long as the generative model is constituted of a neural network such as a GAN that performs adversarial generative learning of image pairs such as pix2pix as described above. In addition, as long as the neural network constituting the generative model according to the present embodiment is configured so as to be capable of obtaining a generative model that generates a label image when an anomalous portion image is input, the neural network constituting the generative model according to the present embodiment may be configured in any way.

As described above, label image generator 102 can generate, from an anomalous portion image obtained by image obtainer 101, a label image including a color label portion depicted in a color corresponding to respective fault modes of the anomalous portion of the anomalous portion image.

Note that an anomalous portion image for training of the image pair that is prepared when training the generative model may be subjected to histogram adjustment so that a white-out uniformly occurs in a background region excluding a region indicating the anomalous portion or, in other words, so that the background region is uniformly converted to a uniform white color indicated by a value of 255 grayscale. Accordingly, since only information necessary for the generative model to generate label images can be extracted in advance, the generative model can be trained to become a generative model that can generate label images with higher accuracy. Note that when the anomalous portion image for training that is an image subjected to histogram adjustment is to be used for training, it is sufficient as long as an image subjected to histogram adjustment is used also for an inspection image to be used for inspection.

### 1-2-3. Non-Dark-Dot Defect Determiner 103

Non-dark-dot defect determiner 103 determines, based on the color of the region in the label image, whether the fault mode of the anomalous portion has a possibility of being a seepage defect in which moisture has seeped into the light-emitting layer of the pixel region. Note that non-dark-dot defect determiner 103 can realize a determination function by having a processor execute a control program stored in a memory in, for example, a computer that realizes the functions of inspection device 10.

In the present embodiment, non-dark-dot defect determiner 103 obtains a label image generated by label image generator 102 and determines whether or not the fault mode of the anomalous portion corresponding to the color label portion is not a dark-dot defect based on the color of the color label portion included in the obtained label image. For example, it is assumed that non-dark-dot defect determiner 103 has obtained label image 44 illustrated in FIG. 9 having been generated by label image generator 102. In this case, non-dark-dot defect determiner 103 determines that the fault mode of anomalous portion 31b corresponding to color label portion 31c is not a dark-dot defect based on the color of color label portion 31c in obtained label image 44.

In this manner, non-dark-dot defect determiner 103 can determine that the fault mode of anomalous portion 31b corresponding to color label portion 31c of obtained label image 44 may possibly be a seepage defect.

Note that when the fault mode of anomalous portion 31b corresponding to color label portion 31c is a normal state, non-dark-dot defect determiner 103 is to terminate the processing with respect to the anomalous portion image because the inspection result in the DS inspection is OK (good).

### 1-2-4. Size Measurer 104

When non-dark-dot defect determiner 103 determines that the fault mode of the anomalous portion has the possibility of being the seepage defect, size measurer 104 measures the size of the region of the color label portion in the label image to determine whether the size measured is greater than or equal to a predetermined value. Note that size measurer 104 can realize a measurement function by image processing by having a processor execute a control program stored in a memory in, for example, a computer that realizes the functions of inspection device 10.

FIG. 13 is a diagram for conceptually describing a size measurement of color label portion 31c of label image 44 according to the present embodiment.

In the present embodiment, for example, size measurer 104 obtains label image 44 shown in FIG. 9 of which the fault mode has been determined by non-dark-dot defect determiner 103 not to be a dark-dot defect and, for example, measures the size of a region of color label portion 31c in label image 44 by image processing as illustrated in FIG. 13. In the example illustrated in FIG. 13, size measurer 104 measures X μm and Y μm or, in other words, the longitudinal (vertical direction) size and the transverse (horizontal direction) size as the size of the region of color label portion 31c in label image 44. X μm and Y μm illustrated in FIG. 13 are, for example, 57 μm and 83 μm.

As described above, size measurer 104 can automatically measure the size of a region of color label portion 31c of label image 44 and determine whether the size of a seepage region is equal to or greater than a predetermined value.

### 1-2-5. DS Determiner 105

When size measurer 104 determines that the size of the region of the color label portion in the label image is greater than or equal to the predetermined value, DS determiner 105 determines that the fault mode of the anomalous portion is the seepage defect. Note that DS determiner 105 can realize the determination function described above by having a processor execute a control program stored in a memory in a computer that realizes the functions of inspection device 10.

In the present embodiment, for example, DS determiner 105 determines that the fault mode of anomalous portion 31a corresponding to color label portion 31c is the seepage defect when the size of the region of color label portion 31c in label image 44 illustrated in FIG. 13 is equal to or greater than the predetermined value.

In this manner, DS determiner 105 can automatically determine whether or not the fault mode of an anomalous portion corresponding to a color label portion of a label image is a seepage defect based on the color and the size of a region of the color label portion.

### 1-3. Operations of Inspection Device 10

An example of operations of inspection device 10 configured as described above will be described below.

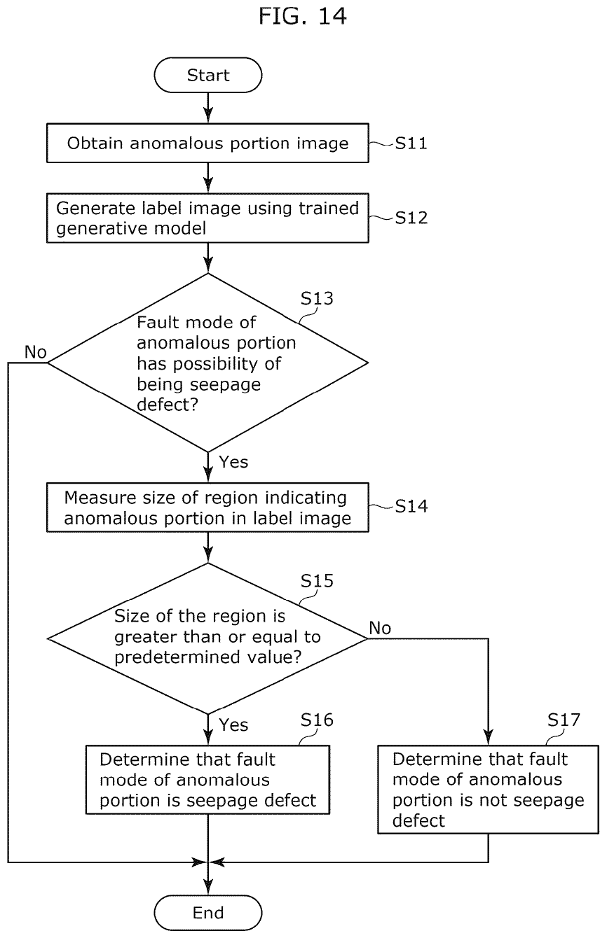

FIG. 14 is a flowchart showing operations of inspection device 10 according to the present embodiment.

First, inspection device 10 obtains an anomalous portion image (S11). More specifically, image obtainer 101 obtains an anomalous portion image that is a background subtraction image including an anomalous portion of a pixel region of organic EL display panel 30. Here, the anomalous portion is acquired by performing image processing using a background subtraction method on an inspection image of the pixel region. For example, image obtainer 101 obtains anomalous portion image 43 that is an image including anomalous portion 31b as illustrated in FIG. 8.

Next, inspection device 10 generates a label image using a trained generative model (S12). More specifically, label image generator 102 generates, using a trained generative model, a label image from the anomalous portion image obtained in step S11, by converting a region indicating the anomalous portion into a region of a color corresponding to the fault mode of the anomalous portion. For example, by converting the region of anomalous portion 31b to the color label corresponding to the fault mode of anomalous portion 31b from anomalous portion image 43 illustrated in FIG. 8 using the trained generative model, label image generator 102 generates label image 44 including color label portion 31c as illustrated in FIG. 9.

Next, inspection device 10 determines whether the fault mode of the anomalous portion has a possibility of being a seepage defect (S13). More specifically, non-dark-dot defect determiner 103 determines, based on the color of the region in the label image generated in step S12, whether the fault mode of the anomalous portion has a possibility of being a seepage defect in which moisture has seeped into the light-emitting layer of the pixel region in the pixel region. For example, it is sufficient as long as non-dark-dot defect determiner 103 determines that the fault mode of anomalous portion 31b corresponding to color label portion 31c of label image 44 illustrated in FIG. 9 is not a dark-dot defect based on the color of color label portion 31c.

When the fault mode of the anomalous portion has the possibility of being a seepage defect in step S13 (Yes in S13), inspection device 10 measures the size of the region indicating the anomalous portion of the label image generated in step S12 (S14). More specifically, when the fault mode of the anomalous portion is determined, in step S13, to have the possibility of being the seepage defect, size measurer 104 measures the size of the region of the color label portion in the label image to determine whether the size measured is greater than or equal to a predetermined value. For example, when it is determined that the fault mode is a dark-dot defect and is not a normal state based on label image 44 illustrated in FIG. 9, size measurer 104 measures the size of a region of color label portion 31c in label image 44 by image processing as illustrated in FIG. 13. Note that when the fault mode of the anomalous portion does not have the possibility of being a seepage defect in step S13 (No in S13), inspection device 10 terminates the present processing or, in other words, the DS inspection.

Next, inspection device 10 determines whether the size of the region measured in step S14 is greater than or equal to a predetermined value (S15). More specifically, DS determiner 105 determines, in step S15, whether the size of the region of the color label portion in the label image measured in step S14 is greater than or equal to a predetermined value. In the present embodiment, the predetermined value is a value in the order of several 10 microns.

When the size of the region is determined, in step S15, to be greater than or equal to the predetermined value (Yes in S15), inspection device 10 determines that the fault mode of the anomalous portion obtained in step S11 is the seepage defect (S16). More specifically, DS determiner 105 determines that the fault mode of the anomalous portion is the seepage defect when the size of the region of the color label portion in the label image is determined, in step S15, to be greater than or equal to the predetermined value. For example, DS determiner 105 determines that the fault mode of anomalous portion 31a corresponding to color label portion 31c is the seepage defect when the size of the region of color label portion 31c in label image 44 illustrated in FIG. 13 is greater than or equal to the predetermined value.

On the other hand, when the size of the region is determined, in step S15, to be not greater than or equal to the predetermined value (No in S15), inspection device 10 determines that the fault mode of the anomalous portion of the anomalous portion image obtained in step S11 is not the seepage defect (S17). More specifically, DS determiner 105 determines that the fault mode of the anomalous portion is not the seepage defect when the size of the region of the color label portion in the label image is determined, in step S15, to be less than the predetermined value. For example, DS determiner 105 determines that the fault mode of anomalous portion 31a corresponding to color label portion 31c is not the seepage defect when the size of the region of color label portion 31c in label image 44 illustrated in FIG. 13 is less than the predetermined value. In addition, DS determiner 105 determines that the pixel region of organic EL display panel 30 including an anomalous portion image including anomalous portion 31a is a good product.

### 1-4. Advantageous Effects Etc.

Inspection device 10 and the like according to the present embodiment obtains an anomalous portion image that is an image including an anomalous portion of a pixel region of organic EL display panel 30, by performing image processing using a background subtraction method on an inspection image of the pixel region. In addition, inspection device 10 and the like according to the present embodiment generates, using a trained generative model, a label image from the anomalous portion image obtained, by converting a region indicating the anomalous portion into a region of a color corresponding to the fault mode of the anomalous portion. Subsequently, whether the fault mode of the anomalous portion has a possibility of being a seepage defect is determined based on the color of the region in the label image generated.

As described above, by using a trained generative model, inspection device 10 and the like according to the present embodiment can generate, from an anomalous portion image that is a background subtraction image including an anomalous portion in a pixel region, a label image in which a missing portion partially shielded by the BM in the anomalous portion is complemented and which is color-coded for each fault mode. In other words, with inspection device 10 and the like according to the present embodiment, a determination of a fault mode in a pixel region of organic EL display panel 30 can be automatically performed.

Here, inspection device 10 and the like according to the present embodiment measures the size of the region of a color label portion in the label image to determine whether the size measured is greater than or equal to a predetermined value when the fault mode of the anomalous portion is determined to have the possibility of being the seepage defect.

Since such a size or, in other words, the size of the color label indicating the seepage region that may possibly be a seepage defect where a missing portion has been complemented can be readily measured, whether or not an anomalous portion of a pixel region is a seepage defect can be readily automatically determined with high accuracy. In other words, with inspection device 10 and the like according to the present embodiment, a determination of a fault mode in a pixel region of organic EL display panel 30 can be automatically performed.

Therefore, since a determination of the fault mode and a measurement of the size of a seepage region which have been left to an operator's judgment in DS inspections can be automated, problems such as an occurrence of differences in judgment criteria among operators and an occurrence of fluctuations in judgment criteria over time even with the same operator can be resolved. As a result, since DS inspections can be performed consistently with the same standards, not only can inspection efficiency be significantly improved but overkill and underkill problems can also be resolved.

Note that with inspection device 10 and the like according to the present embodiment, a method using a trained generative model such as a generative model constituted of a neural network is used as a method of generating a label image.

That is to say, the trained generative model is trained using an anomalous portion image for training and a label image for training that are prepared as teaching data. The anomalous portion image for training is a background subtraction image obtained by performing image processing using the background subtraction method on an inspection image of the pixel region of organic EL display panel 30. The label image for training is an image obtained by converting a region indicating an anomalous portion shown in the anomalous portion image for training, into a region of a color corresponding to the fault mode of the anomalous portion. The fault mode of the anomalous portion indicates the dark-dot defect, the seepage defect, or a normal state. Here, the trained generative model is a GAN-based neural network model and may be, for example, a Pix2Pix neural network model.

Accordingly, the generative model can be trained in advance by preparing an image pair of a background subtraction image for training (anomalous portion image for training) and a label image for training (in which a missing portion is complemented and which is color-coded for each fault mode) which indicate various fault modes including a seepage defect and a dark-dot defect. Therefore, using a generative model being a neural network model that is good at recognition and complementation enables a label image with color label portions in which a missing portion has been complemented and which have been color-coded for each fault mode to be automatically generated with high accuracy from an anomalous portion image obtained by applying image processing using the background subtraction method. As a result, since the label image can be used to accurately and automatically determine the fault mode and measure the size of the seepage region, it is possible to accurately and automatically determine whether or not an anomalous portion in the pixel region is a seepage defect.

Note that an anomalous portion image for training may be subjected to histogram adjustment so that a white-out uniformly occurs in a background region excluding a region indicating the anomalous portion or, in other words, so that the background region is converted to a uniform white color indicated by a value of 255 grayscale. Accordingly, since only information necessary for the generative model to generate label images can be extracted in advance, the generative model can be trained to be able to generate label images with higher accuracy.

### Variation

Note that in the embodiment described above, a label image was generated from an anomalous portion image of a background subtraction image using a trained generative model and a determination of whether or not the fault mode of an anomalous portion is a seepage defect is made using the generated label image. To further improve the determination accuracy of whether the fault mode of an anomalous portion is a seepage defect, a model that differs from the generative model or, in other words, a CNN (Convolutional Neural Network) model may be used to determine the fault mode of the anomalous portion and to double-check the determination result. Hereinafter, this case will be described with a focus on points that differ from the embodiment described above.

### 2-1. Inspection Device 10A

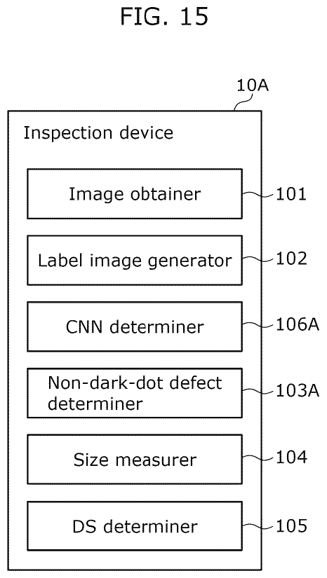

FIG. 15 is a block diagram illustrating an example of a functional configuration of inspection device 10A according to a variation of the present embodiment. Inspection device 10A according to the present variation differs from inspection device 10 illustrated in FIG. 6 in that CNN determiner 106A has been added and non-dark-dot defect determiner 103A has a different function.

### 2-1-1. CNN Determiner 106A

CNN determiner 106A can determine the fault mode of an anomalous portion using a model that differs from the generative model. More specifically, CNN determiner 106A obtains, from the anomalous portion image by using a trained CNN model, a classification result indicating the fault mode of the anomalous portion. Note that CNN determiner 106A can realize the determination function described above by having a processor execute a control program stored in a memory in a computer that realizes the functions of inspection device 10A.

A trained CNN model is trained as follows. Specifically, first, as teaching data, an anomalous portion image for training that is a background subtraction image is prepared in plurality for each class number corresponding to the fault mode. Note that the anomalous portion image for training is the anomalous portion image for training according to the embodiment described above and is a background subtraction image obtained by performing image processing using the background subtraction method on an inspection image of the pixel region of organic EL display panel 30. In addition, the class number can be determined, for example, 0 for a normal state, 1 for a seepage defect, 2 for a dark-dot defect, 4 for a mixture of a seepage defect and a dark-dot defect, and so on. Alternatively, the class number for a mixture of a seepage defect and a dark-dot defect may be 1 and 2. Furthermore, the CNN model is trained so that input is the anomalous portion image for training and output is the class number. Using the trained CNN model obtained by such training, CNN determiner 106A can obtain a classification result indicating the fault mode of an anomalous portion from the anomalous portion image.

### 2-1-2. Non-Dark-Dot Defect Determiner 103A

Non-dark-dot defect determiner 103A has a function of double-checking a determination result in addition to the function described in the embodiment described above. In other words, non-dark-dot defect determiner 103A further determines whether the fault mode of the anomalous portion has the possibility of being the seepage defect, based on the classification result obtained by CNN determiner 106A and the color of the region in the label image. As described above, since an automatic determination result can be double-checked, the determination accuracy of a seepage defect can be further improved. Note that non-dark-dot defect determiner 103A can realize a determination function by having a processor execute a control program stored in a memory in, for example, a computer that realizes the functions of inspection device 10A.

More specifically, non-dark-dot defect determiner 103A determines whether the fault mode of the anomalous portion has the possibility of being the seepage defect when the fault mode indicated by the classification result obtained by CNN determiner 106A and the fault mode indicated by the color of the region in the label image are identical. On the other hand, when the fault mode indicated by the classification result obtained by CNN determiner 106A and the fault mode indicated by the color of the region in the label image are not identical, non-dark-dot defect determiner 103A makes a notification that the fault modes are not identical. By doing so, non-dark-dot defect determiner 103A can cause an operator to determine whether the fault mode of the anomalous portion has the possibility of being the seepage defect. It is sufficient as long as the operator determines whether there is a possibility that the fault mode of the anomalous portion is a seepage defect or, in other words, whether a seepage region exists in the anomalous portion image. In addition, when there is a possibility that the fault mode of the anomalous portion is a seepage defect or, in other words, when a seepage region exists in the anomalous portion image, it is sufficient as long as the size of the seepage region is measured and a determination as to whether the size is equal to or greater than a predetermined value is made.

### 2-2. Operation of Inspection Device 10A

An example of operations of inspection device 10A configured as described above will be described below.

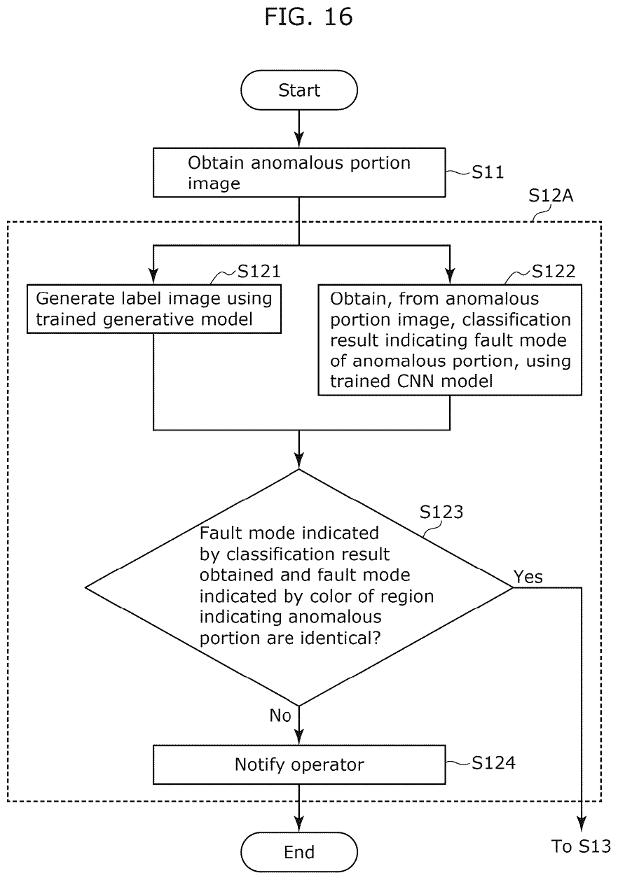

FIG. 16 is a flowchart showing a part of operations of inspection device 10A according to the variation of the present embodiment. Operations of inspection device 10A according to the present variation differ from the operations of inspection device 10 illustrated in FIG. 14 in processing contents of step S12. More specifically, in the present variation, processing of step S12A illustrated in FIG. 16 is performed in place of the processing of step S12 illustrated in FIG. 14.

First, inspection device 10A obtains an anomalous portion image (S11). More specifically, image obtainer 101 obtains an anomalous portion image that is a background subtraction image including an anomalous portion of a pixel region of organic EL display panel 30. Here, the anomalous portion is acquired by performing image processing using a background subtraction method on an inspection image of the pixel region.

Next, in step S12A, inspection device 10A generates a label image using a trained generative model (S121). More specifically, label image generator 102 generates, using a trained generative model, a label image from the anomalous portion image obtained in step S11, by converting a region indicating the anomalous portion into a region of a color corresponding to the fault mode of the anomalous portion.

In addition, in step S12A, inspection device 10A obtains, from the anomalous portion image obtained in step S11, a classification result indicating the fault mode of the anomalous portion, by using a trained CNN model (S122). More specifically, CNN determiner 106A obtains, from the anomalous portion image obtained in step S11, a classification result indicating the fault mode of the anomalous portion, by using a trained CNN model.

Next, in step S12A, inspection device 10A determines whether the fault mode indicated by the classification result obtained in step S122 and the fault mode indicated by the color indicating the anomalous portion of the label image generated in step S121 are identical (S123).

In step S123, when the fault modes are identical (Yes in S123), the process advances to step S13 illustrated in FIG. 14. As described above, by double-checking a determination of the fault mode of an anomalous portion, the determination accuracy of a seepage defect can be further improved.

On the other hand, when the fault modes are not identical in step S123 (No in S123), an operator is notified that the fault modes are not identical (S124). As described above, by double-checking a determination of the fault mode of an anomalous portion and letting the operator make a judgment when the fault modes are not identical, a seepage defect can be determined in a more error-free manner.

### 2-3. Advantageous Effects Etc.

In the present variation, to further improve the determination accuracy of inspection device 10 according to the embodiment, a CNN model is prepared separately from the generative model and the CNN model is trained using an anomalous portion image for training that is a background subtraction image classified into fault modes in advance. Accordingly, when an anomalous portion image that is a background subtraction image is input, the trained CNN can output a class number corresponding to the fault mode.

In addition, inspection device 10A and the like according to the present variation generates a label image from an anomalous portion image using a trained generative model and obtains a classification number corresponding to the fault mode of an anomalous portion of an anomalous portion image using a trained CNN. Inspection device 10A and the like according to the present variation can double-check an automatic determination result by collating the fault mode determined using the label image generated using the trained generative model with a classification result indicating the fault mode obtained using the trained CNN model. Accordingly, determination accuracy of a seepage defect can be further improved. Note that when it is found that the fault mode determined using the generative model and the classification result indicating a fault mode are not identical as a result of a double-check, the operator may be asked to make a judgment. Letting the operator make a judgment when the fault modes are not identical enables a seepage defect to be determined in a more error-free manner.

### Other Embodiments

Hereinbefore, an inspection device, an inspection method, and the like according to the present disclosure have been described based on an embodiment and variation, but the present disclosure is not limited to the above embodiment and variation.

Various modifications of the embodiment and variation as well as other forms resulting from combinations of some of the constituent elements in the embodiment and variation that may be conceived by those skilled in the art are also included within the scope of the present disclosure so long as these do not depart from the essence of the present disclosure.

The following forms may also be included within the scope of one or more aspects of the present disclosure.

(1) One or more of the constituent elements included in the inspection device described above may be a computer system including a microprocessor, ROM, RAM, GPU, a hard disk unit, a display unit, a keyboard, a mouse, etc. The RAM or hard disk unit stores a computer program. The microprocessor fulfills the functions by operating in accordance with the computer program. Here, the computer program is configured by combining a plurality of instruction codes indicating instructions to the computer in order to fulfill a given function.

(2) One or more of the constituent elements included in the inspection device described above may be configured as a single system large scale integration (LSI) circuit. A system LSI is a super multifunctional LSI manufactured by integrating a plurality of elements on a single chip, and is specifically a computer system including, for example, a microprocessor, ROM, RAM, and GPU. A computer program is stored in the RAM. The system LSI circuit fulfills the functions as a result of the microprocessor or GPU operating according to the computer program.

(3) One or more of the constituent elements included in the inspection device described above may be configured as an IC card or standalone module attachable to and detachable from each device. The IC card or module is a computer system including, for example, a microprocessor, ROM, RAM, and GPU. The IC card or module may include the above-described super multifunctional LSI. The IC card or module fulfills the functions as a result of the microprocessor or GPU operating according to a computer program. The IC card or module may be tamperproof.

(4) In addition, one or more of the constituent elements included in the inspection device described above may be a computer-readable recording medium, such as a flexible disk, a hard disk, a CD-ROM, an MO, a DVD, a DVD-ROM, DVD-RAM, a Blu-ray Disc (BD; registered trademark), semiconductor memory, etc., having recording thereon the computer program or the digital signal. One or more of the constituent elements included in the inspection device described above may be the digital signal recorded on these recording media.

In addition, one or more of the constituent elements included in the inspection device described above may transmit the computer program or the digital signal via, for example, a telecommunication line, a wireless or wired communication line, a network such as the Internet, or data broadcasting.

(5) The present disclosure may be the methods described above. Also, the present disclosure may be a computer program realizing these methods with a computer, or a digital signal of the computer program.

(6) Moreover, the present disclosure may be a computer system including a microprocessor, GPU, and memory. The memory may have the computer program stored therein, and the microprocessor or GPU may operate according to the computer program.

(7) In addition, the present disclosure may be implemented by another independent computer system by recording the program or the digital signal on the recording medium and transporting it, or by transporting the program or the digital signal via the network, etc.

(8) Furthermore, one or more of the constituent elements included in the inspection device described above may be implemented in the cloud or by a server device.

(9) The above embodiments and variations may be arbitrarily combined.

### INDUSTRIAL APPLICABILITY

The present disclosure can be used for inspection methods, inspection devices, programs, and the like that can automatically determine whether there is a black stain-like display defect caused by a fault in a moisture barrier layer in an inspection step of inspecting a display defect of a pixel region of an organic EL display panel or a display panel using quantum dot light emitting devices.

### REFERENCE SIGNS LIST

10, 10A inspection device
20 imaging device
21 stage
22 stage driver
30 organic EL display panel
31a, 31b, 61a anomalous portion
31c, 62b color label portion
41 anomalous pixel image
42 normal pixel image
43, 61 anomalous portion image
44, 62 label image
91, 92 enlarged image
101 image obtainer
102 label image generator
103, 103A non-dark-dot defect determiner
104 size measurer
105 DS determiner
106A CNN determiner
311, 317 glass substrate
312 thin-film transistor layer
313 light-emitting layer
314 protective film
315 filler
316 color filter layer
320 foreign substance
321 penetration path
322 arrow
1000 computer
1001 input device
1002 output device
1003 CPU
1004 internal storage
1005 RAM
1006 GPU
1007 reading device
1008 transmission and reception device
1009 bus

1. An inspection method to be performed by a computer for inspecting a display panel, the inspection method comprising:
obtaining an anomalous portion image that is an image including an anomalous portion of a pixel region of the display panel, the anomalous portion being acquired by performing image processing using a background subtraction method on an inspection image of the pixel region;
generating, using a trained generative model, a label image from the anomalous portion image by converting a region indicating the anomalous portion into a region of a color corresponding to a fault mode of the anomalous portion; and
determining, based on the color of the region in the label image, whether the fault mode of the anomalous portion has a possibility of being a seepage defect in which light is not emitted due to deterioration of a functional layer in the pixel region, wherein
the fault mode includes the seepage defect and a dark-dot defect in which light is not emitted due to an electrical short circuit or an electrical open circuit in the pixel region.

2. The inspection method according to claim 1, further comprising:
prior to the determining, obtaining a classification result from the anomalous portion image by using a trained convolutional neural network (CNN) model, the classification result indicating the fault mode of the anomalous portion, wherein
in the determining, whether the fault mode of the anomalous portion has the possibility of being the seepage defect is determined based on the classification result obtained in the obtaining of the classification result and the color of the region in the label image.

3. The inspection method according to claim 2, wherein
in the determining, whether the fault mode of the anomalous portion has the possibility of being the seepage defect is determined by the computer when the fault mode indicated by the classification result obtained in the obtaining of the classification result and the fault mode indicated by the color of the region in the label image are identical, and
when the fault modes are not identical, a notification that the fault modes are not identical is made to cause an operator to determine whether the fault mode of the anomalous portion has the possibility of being the seepage defect,
the inspection method further comprising:
measuring a size of the region in the label image to determine whether the size measured is greater than or equal to a predetermined value when, in the determining, the fault mode of the anomalous portion is determined to have the possibility of being the seepage defect; and
determining that the fault mode of the anomalous portion is the seepage defect when the size of the region is determined, in the measuring, to be greater than or equal to the predetermined value.

4. The inspection method according to claim 1, comprising:
measuring a size of the region in the label image to determine whether the size measured is greater than or equal to a predetermined value when, in the determining, the fault mode of the anomalous portion is determined to have the possibility of being the seepage defect; and
determining that the fault mode of the anomalous portion is the seepage defect when the size of the region is determined, in the measuring, to be greater than or equal to the predetermined value.

5. The inspection method according to claim 1, wherein
the trained generative model is trained using (i) an anomalous portion image for training that is obtained by performing image processing using the background subtraction method on an inspection image of the pixel region of the display panel and (ii) a label image for training that is obtained by converting a region indicating an anomalous portion shown in the anomalous portion image for training, into a region of a color corresponding to a fault mode of the anomalous portion, the anomalous portion image for training and the label image for training being prepared as teaching data, and
the fault mode of the anomalous portion indicates the dark-dot defect, the seepage defect, or a normal state.

6. The inspection method according to claim 5, wherein
the trained generative model is a generative adversarial networks (GAN)-based neural network model.

7. The inspection method according to claim 5, wherein
the trained generative model is a Pix2Pix neural network model.

8. The inspection method according to claim 5, wherein
the anomalous portion image for training is subjected to histogram adjustment to make a background region uniformly white, the background region excluding the region indicating the anomalous portion.

9. An inspection device that inspects a display panel using a computer, the inspection device comprising:
an image obtainer that obtains an anomalous portion image that is an image including an anomalous portion of a pixel region of the display panel, the anomalous portion being acquired by performing image processing using a background subtraction method on an inspection image of the pixel region;
a label image generator that generates, using a trained generative model, a label image from the anomalous portion image by converting a region indicating the anomalous portion into a region of a color corresponding to a fault mode of the anomalous portion; and
a non-dark-dot defect determiner that determines, based on the color of the region in the label image, whether the fault mode of the anomalous portion has a possibility of being a seepage defect in which light is not emitted due to deterioration of a functional layer in the pixel region, wherein
the fault mode includes the seepage defect and a dark-dot defect in which light is not emitted due to an electrical short circuit or an electrical open circuit in the pixel region.

10. A non-transitory computer-readable recording medium having recorded thereon a program for causing a computer to perform an inspection method for inspecting a display panel, the inspection method including:
obtaining an anomalous portion image that is an image including an anomalous portion of a pixel region of the display panel, the anomalous portion being acquired by performing image processing using a background subtraction method on an inspection image of the pixel region;
generating, using a trained generative model, a label image from the anomalous portion image by converting a region indicating the anomalous portion into a region of a color corresponding to a fault mode of the anomalous portion; and
determining, based on the color of the region in the label image, whether the fault mode of the anomalous portion has a possibility of being a seepage defect in which light is not emitted due to deterioration of a functional layer in the pixel region, wherein
the fault mode includes the seepage defect and a dark-dot defect in which light is not emitted due to an electrical short circuit or an electrical open circuit in the pixel region.
